(19) United States
(12) Patent Application Publication
(10) Pub. No.: US 2015/0227501 A1
(43) Pub. Date: Aug. 13, 2015

(54) GRAPHICAL OPERATIVE NOTES

(71) Applicant: Arthrex, Inc., Naples, FL (US)

(72) Inventors: Laith Farjo, Ann Arbor, MI (US); Craig Speier, Santa Barbara, CA (US)

(21) Appl. No.: 14/617,011

(22) Filed: Feb. 9, 2015

Related U.S. Application Data
(60) Provisional application No. 61/937,171, filed on Feb. 7, 2014.

(51) Int. Cl. G06F 17/24; G06F 3/0484

(52) U.S. Cl. CPC G06F 17/241; G06F 3/04847; G06F 3/04842

(57) ABSTRACT

A system for graphically generating operative notes, the system having a processor; an input device coupled to the processor; a display device coupled to the processor; and a memory system coupled to the processor, the memory system having graphical representations of at least one of the group consisting of anatomical structures, diagnoses, and medical procedures; text descriptions corresponding to the graphical representations; and instructions executable on the processor for: displaying the graphical representations on the display device for a user to select; receiving selected graphical representations from the user; using text corresponding to the selected graphical representations to generate text for operative notes; and allowing the user to edit the generated text using the input device.

### CROSS REFERENCE TO RELATED APPLICATION

This application claims priority of U.S. Provisional Patent Application No. 61/937,171, filed on Feb. 7, 2014, entitled GRAPHIC OPERATIVE NOTES, the entire contents of which are hereby incorporated herein by reference.

### BACKGROUND OF THE INVENTION

This invention relates generally to operative notes and, more particularly to an improved system and method for generating operative notes.

An operative note is a written record regarding a surgical procedure, such as an operation to repair a joint. Operative notes are important for documentation of the surgical procedure performed, later consultation with patients, other medical professionals and third parties, such as insurance providers. Appropriate documentation of surgical procedures is often a time consuming task. Moreover, timely documentation can be difficult to prepare in an efficient manner. Typically, hospitals invest in dictation systems in efforts to decrease time spent in preparing operative notes and increase efficiency. However, dictation systems are often very costly and suffer from errors in transcription. Also, surgeon compliance with timely dictation is often inadequate.

Therefore, there is a need for an improved method for generating operative notes.

### SUMMARY

Accordingly, the present invention is directed to a system and method for preparing operative notes that remedies the shortcomings of the prior art.

The present invention, according to an embodiment, is directed to a system for graphically generating operative notes, the system comprising: a processor; an input device coupled to the processor; a display device coupled to the processor; and a memory system coupled to the processor. The memory system has graphical representations of anatomical structures, diagnoses and medical procedures. The memory system also has text descriptions corresponding to the graphical representations. The memory system also contains instructions executable on the processor for: displaying the graphical representations on the display device for a user to select; receiving selected graphical representations from the user; using text corresponding to the selected graphical representations to generate text for operative notes; and allowing the user to edit the generated text using the input device.

The memory system may also have data regarding at least one of a patient, a medical facility and medical personnel; and the instructions executable on the processor may include instructions for using the data regarding at least one of a patient, a medical facility and medical personnel to generate text for operative notes. The memory system may also have text descriptions for pre-operative diagnoses, procedures, anesthesia, indications or post-operative diagnoses; and the instructions executable on the processor may include instructions for selecting from the text descriptions based on the selected graphical representations and the data regarding at least one of a patient, a medical facility, a medical procedure and medical personnel to generate text for operative notes.

The instructions executable on the processor may provide graphical representations based on the user of the system and based on a medical procedure. The system may reside on a mobile computing device. The display device may be a display screen of the mobile computing device and the input device may be a touch screen of the mobile computing device. The memory system may have operative photographs of a patient. The instructions executable on the processor may prompt the user to select operative photographs for inclusion in operative notes and for including selected operative photographs in the operative notes.

In an additional embodiment, the present invention is directed to a method for generating operative notes, the method having the steps of: providing a user with graphic representations of anatomical structures, diagnoses and medical procedures; prompting the user to graphically indicate at least one diagnosis using the graphic representations; receiving a graphic indication of at least one diagnosis from the user; generating operative note text from the received graphic indication of at least one diagnosis; prompting the user to graphically indicate at least one medical procedure using the graphic representations; receiving a graphic indication of at least one medical procedure from the user; and generating operative note text from the received graphic indication of at least one medical procedure.

The method may also have the steps of: prompting the user to login to the system using a password; receiving the password from a user; authenticating the password received from the user; prompting the user to select from a plurality of different cases; receiving a case selection from the user; retrieving data corresponding to the selected case from a memory; and populating a portion of an operative note with the retrieved data. The retrieved data may contain a patient name, a patient sex, a patient date of birth, and a patient medical record number.

The method may also have the steps of: storing information about at least one of a medical facility and medical personnel in a storage device; retrieving the information about at least one of a medical facility and medical personnel from the storage device; and populating a portion of an operative note based on the retrieved information about at least one of a medical facility and medical personnel from the storage device.

The method may also have the steps of: storing text descriptions for diagnoses, medical procedures, anesthesia, indications and post-operative diagnoses in a storage device; and selecting text from the text descriptions based on the received graphic indication of at least one diagnosis, the received graphic indication of at least one medical procedure, the retrieved data corresponding to the selected case and the retrieved information about at least one of a medical facility and medical personnel.

The method also has the steps of prompting the user to review a draft operative note; receiving edits from the user; and generating a final operative note. The method also has the steps of: prompting the user to select from a plurality of destinations for the final operative note; receiving at least one destination selection from the user; and sending the final operative note the to the at least one selected destination.

The step of providing the user with portions of an operative note containing graphic representations may include selecting graphic representations based on the user. The steps of generating operative note text from the received graphic indication of at least one diagnosis and generating operative note text from the received graphic indication of at least one medical procedure may further include selecting text based on the user.

The present invention, according to additional embodiment, is directed to a system for graphically generating operative notes, the system comprising: an operative note generating module further comprising; a processor; a first memory system coupled to the processor, the memory system comprising graphical representations of anatomical structures, diagnoses, and medical procedures; an input device coupled to the processor; and a display device coupled to the processor; a data storage system coupled to the operative note generating module, the data storage system further comprising data regarding a patient, a medical facility and medical personnel. The operative note generating module processor is configured to: provide the graphical representations to a user for selection; receive selected graphical representations from a user; use the selected graphical representations to generate text for operative notes; and use the data regarding at least one of a medical facility and medical personnel to generate text for operative notes.

The first memory system may also have text descriptions for at least one of pre-operative diagnoses, procedures, anesthesia, indications and post-operative diagnoses. The processor may be further configured to select from the text descriptions based on the selected graphical representations and the data regarding a patient, a medical facility, a medical procedure and medical personnel to generate an operative note.

The system may reside on a mobile computing device where the display device is a display screen of the mobile computing device and the input device is a touch screen of the mobile computer device.

### BRIEF DESCRIPTION OF THE DRAWINGS

The features, aspects and advantages of the present invention will become better understood with regard to the following description, appended claims and accompanying figures wherein:

FIG. 1 is a schematic diagram of a system for generating operative notes according to an embodiment of the present invention;

FIG. 2 is a screen shot showing a login screen generated by a system for generating operative notes according to an embodiment of the present invention;

FIG. 3 is a screen shot showing a case selection screen generated by a system for generating operative notes according to an embodiment of the present invention;

FIG. 4 is a screen shot showing an operative report overview screen generated by a system for generating operative notes according to an embodiment of the present invention;

FIG. 5 is a screen shot showing a procedure general information screen generated by a system for generating operative notes according to an embodiment of the present invention;

FIG. 6 is a screen shot showing a procedure general information screen generated by a system for generating operative notes according to an embodiment of the present invention wherein a user is prompted to graphically indicate diagnosis information;

FIG. 7 is a screen shot showing a diagnosis and procedure editing screen generated by a system for generating operative notes according to an embodiment of the present invention wherein a user is prompted graphically indicate diagnosis information;

FIG. 8 is a screen shot showing a diagnosis and procedure editing screen generated by a system for generating operative notes according to an embodiment of the present invention wherein the system provides visual diagnosis information;

FIG. 9 is a screen shot showing a diagnosis and procedure editing screen generated by a system for generating operative notes according to an embodiment of the present invention wherein a user is prompted to select condition, procedure and technique information;

FIG. 10 is a screen shot showing a diagnosis and procedure editing screen generated by a system for generating operative notes according to an embodiment of the present invention wherein a user is prompted to select preoperative or operative photographs for inclusion in an operative note;

FIG. 11 is a screen shot showing a diagnosis and procedure editing screen generated by a system for generating operative notes according to an embodiment of the present invention wherein the user is presented with modified images showing an effect of a procedure;

FIG. 12 is a screen shot showing a diagnosis and procedure editing screen generated by a system for generating operative notes according to an embodiment of the present invention wherein a user has drawn a tear over an image of a knee meniscus;

FIG. 13 is a screen shot showing a diagnosis and procedure editing screen generated by a system for generating operative notes according to an embodiment of the present invention wherein a user is prompted to clarify the diagnosis;

FIG. 14 is a screen shot showing the diagnosis and procedure editing screen of FIG. 13, where further details about the diagnosis and procedure are available for editing;

FIG. 15 is a screen shot showing a diagnosis and procedure editing screen generated by a system for generating operative notes according to an embodiment of the present invention wherein a user is presented with an image showing that a diagnosis and procedure have been addressed;

FIG. 16 is a screen shot showing a diagnosis and procedure editing screen generated by a system for generating operative notes according to an embodiment of the present invention relating to knee chondromalacia;

FIG. 17 is a screen shot showing a diagnosis and procedure editing screen generated by a system for generating operative notes according to an embodiment of the present invention wherein a user is prompted to modify a diagnosis, a severity and a procedure for treating knee chondromalacia;

FIG. 18 is a screen shot showing a diagnosis and procedure editing screen generated by a system for generating operative notes according to an embodiment of the present invention wherein a user is presented with a modified graphic showing an identified diagnosis and procedure;

FIG. 19 is a screen shot showing a diagnosis and procedure editing screen generated by a system for generating operative notes according to an embodiment of the present invention wherein a user is prompted to select one or more images for inclusion in an operative note;

FIG. 20 is a screen shot showing a diagnosis and procedure editing screen generated by a system for generating operative notes according to an embodiment of the present invention wherein a user is presented with an indication that one or more images have been selected for inclusion;

FIG. 21 is a screen shot showing an operative note preview screen generated by a system for generating operative notes according to an embodiment of the present invention;

FIG. 22 is a screen shot showing a detail screen generated by a system for generating operative notes according to an embodiment of the present invention wherein a user is prompted to indicate procedure characteristics by selecting a surgical tool and placing the selected tool at a location on an image;

FIG. 23 is a screen shot showing a detail screen generated by a system for generating operative notes according to an embodiment of the present invention wherein a user is prompted to indicate additional procedure characteristics for a previously indicated procedure;

FIG. 24 is a screen shot showing an operative note review screen generated by a system for generating operative notes according to an embodiment of the present invention;

FIG. 25 is a screen shot showing an operative note review screen generated by a system for generating operative notes according to an embodiment of the present invention wherein a user is provided with an on screen keyboard for editing; and

FIG. 26 is a screen shot showing a sending selection screen generated by a system for generating operative notes according to an embodiment of the present invention.

### DETAILED DESCRIPTION OF THE PREFERRED EMBODIMENTS

In the following description of the preferred embodiments, reference is made to the accompanying drawings which show by way of illustration specific embodiments in which the invention may be practiced. Wherever possible, the same reference numbers will be used throughout the drawings to refer to the same or like parts. It is to be understood that other embodiments may be utilized and structural and functional changes may be made without departing from the scope of the present invention.

An operative note typically contains information about the hospital or surgery center at which the operation is performed and the date and time of the operation. Additionally, the operative note typically contains patient information, such as patient name, medical record number and date of birth. Additionally, the operative note contains staff information, such as the names of the surgeon and any assisting physicians or staff. Additionally, the operative note typically contains preoperative diagnoses, indications and postoperative diagnoses. Additionally, the operative note typically contains operation information, such as the objectives of the operation and a description of the procedure performed, including anesthesia administered.

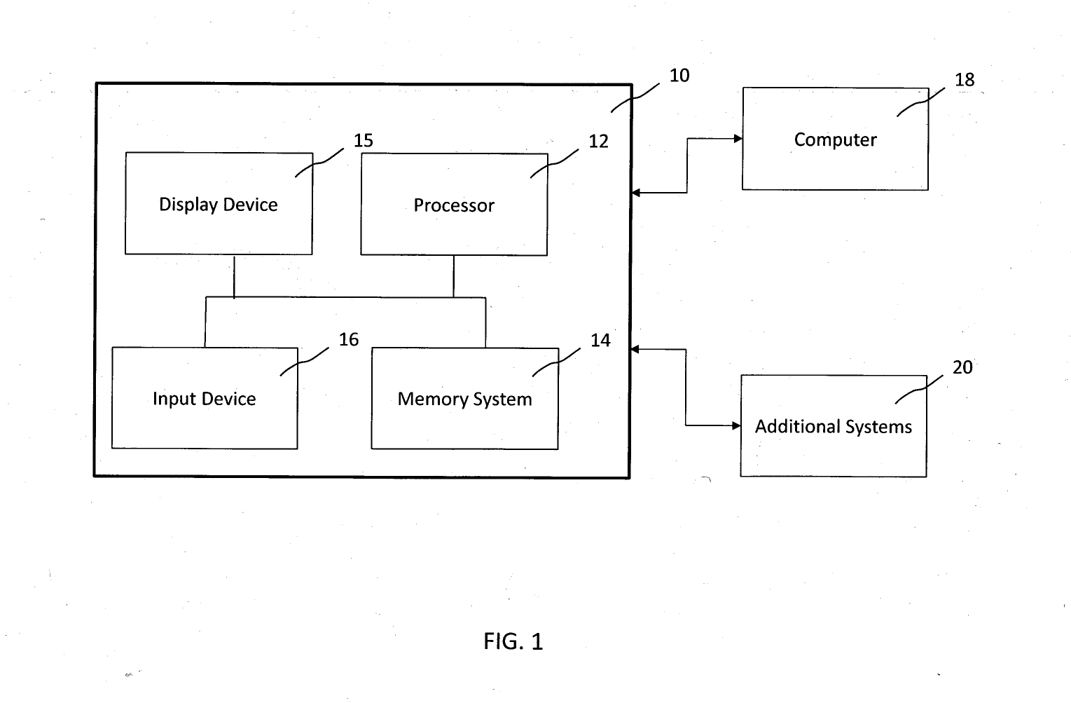

With reference to FIG. 1, the present invention according to an embodiment is directed to a system 10 for creating operative notes. The system of the present invention may be used for many different types of procedures. In embodiments, the system is used for creating reports for common procedures performed by orthopedic surgeons, such as arthroscopic surgery of the knee, shoulder, hip, elbow, wrist, and foot/ankle, carpal tunnel release and hand surgery, joint replacement, fracture open reduction and internal fixation, podiatry and foot/ankle surgery. The system, however, is not specific to orthopedic surgery and is applicable to any surgical field in which a graphical representation of anatomy or pathology can be used to document surgical findings, including general surgery, ophthalmological surgery, otorhinolaryngology surgery, gynecologic surgery, urologic surgery, neurologic surgery, and cardio-thoracic surgery.

The system 10 has a processor 12 operatively coupled to a memory system 14. The memory system 14 may include one or more memory devices (RAM, ROM, disk, or other storage format). The system 10 has a computer program executing on the processor for generating operative notes. The processor 12 is operatively coupled to at least one display device 15. The processor is operatively coupled to at least one input device 16, such as a keyboard, mouse, touchscreen or touchpad. The note generator may also be operatively coupled to a computer 18, such as a tablet computer for receiving input as will be further explained below. The system 10 may be coupled to additional systems 20, such as medical record storage systems, or systems for storing other information. The system 10 may be coupled to the computer 18 and the additional systems 20 via a local area network or over a wide area network such as the Internet.

In an embodiment, the system 10 is located on a server remotely accessible by the computer 18. For example, the computer 18 may be a tablet computer, such as an Apple Computer® Ipad®, that accesses the system server via a wireless network. The system server may be accessible via a local area network. Additionally, the system server may be a cloud computer accessible over the Internet.

Data is loaded in the memory system 14 so that the program may use the data for generating a draft operative note. The data may be loaded in a particular format (e.g., a common spreadsheet format, comma delimited text, or other format). The data may be stored in several different databases in the memory system, with each database being designed to hold data relevant to a different part of an operative note.

In an embodiment, the data saved in the data system 14 includes information likely to recur in various reports at a given surgery center or hospital for given surgeons and staff. For example, information about the name and address of the hospital or surgery center is saved in a database in the memory system 14. Information about doctors, surgeons and staff is saved in a database in the memory system 14.

Information about patients is saved in a database in the memory system 14 or in an additional system 20 accessible by the processor 12. Patient information may include, for example, patient name, sex, date of birth, medical identification number as well as diagnosis information.

Language for typical pre-operative diagnoses, procedures, anesthesia, indications and post-operative diagnoses is saved in a database in the memory system 14. To ease population of the database, language from previously generated operative notes may be copied and saved. The language is highly customizable and may be saved for each surgeon. Moreover, the language is intended to be language universal in that when specific pre-operative diagnoses, procedures, anesthesia, indications and post-operative diagnoses are selected those items may be translated into multiple different languages.

Sample indication text may be stored in the memory system 14 for different symptoms. For example, “The patient is a {xx} year old { sex} who presents with a chief complaint of { side} {extremity} pain and has failed a conservative treatment program. {He/She} has been informed of the indications, risks, benefits, and alternatives to this surgery and does wish to proceed. {He/She} understands that the risks include infection, stiffness, nerve or vascular injury, failure to improve, need for reoperation, and anesthetic complication.” The bracketed portions may be variables that are populated by the program based upon stored patient information, such as the sex and age of the patient and based upon stored medical procedure information. Some indications may be procedure specific and some indications may be generic for all procedures.

Sample procedure text may be stored in memory system 14 describing patient set-up for different procedures (such as knee arthroscopy and shoulder arthroscopy). For example, “The patient was placed on the operating room table. All extremities were carefully padded. A tourniquet was applied on the operative leg. The lower extremity was prepped and draped in a sterile fashion. After administration of IV antibiotics, the lower extremity was exsanguinated and the tourniquet was inflated. An inferolateral portal was established with a #11 blade. The inferomedial portal was established under direct arthroscopic visualization.”

Language saved for typical pre-operative diagnoses, procedures, anesthesia, indications and post-operative diagnoses is highly customizable. Preferably, language is held in variables with standard text that can be modified by the end user. For example, the term “menisectomy” may be translated as “a partial [medial/lateral] menisectomy was performed using a combination of shave and basket punches to trim the meniscus to a stable surface” or “a [medial/lateral] meniscoplasty was achieved by carefully smoothing the torn edges of the meniscus using a shave and electrothermal device” or customized to whatever the surgeon/doctor prefers. Surgeon preferences, including typical language, may be saved to a cloud storage system accessible over the Internet. The text generator can be programmed to perform translations for different languages, such as English, German and Japanese.

Different anatomical images and/or diagrams are stored in the memory system 14 for use by the program in generating a draft operative note. The images and/or diagrams represent different anatomical structures related to the procedure performed. The images and associated workflow may be customized by surgeon and procedure type. The images and/or diagrams may be coded with image maps so that when a portion of an image is selected by a user, such as using the input device 16 or the input computer 18, the program may use the selection to further generate text for the draft operative note. In an embodiment, the program has an overlay such that markings, such as loops or lines made over the images and/or diagrams can be used to generate text for the draft operative note.

Preoperative and operative images may be stored in the memory system 14 for use by the program in generating a draft operative note. The images and associated workflow may be customized by surgeon and procedure type.

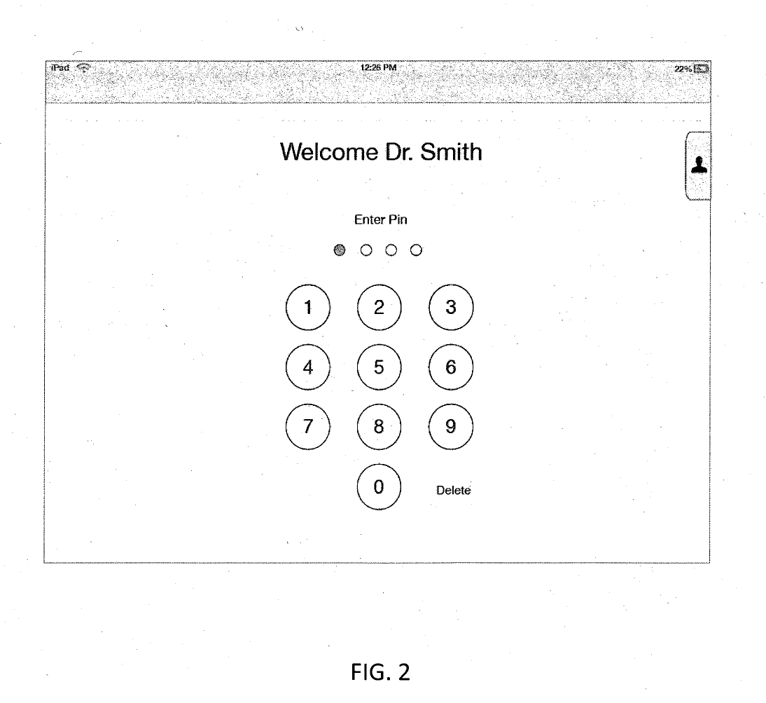

With reference to FIGS. 2 to 26, the present invention according to an embodiment, is directed to a method for creating operative notes. As shown in FIG. 2, a user, such as a surgeon, is prompted to login to the program using the input device 16 or the input computer 18. This prevents unauthorized access to the system. In additional embodiments of the present invention, a user may gain access to the system using additional login criteria, such as biometric authentication. Staff, such as an operating room nurse, may also be able to login and make selections for an operative notice to reduce the amount of time spent by the surgeon later. Additionally, a surgeon may dictate selections or information to a staff member during the course of a procedure, to enable that staff member to make selections for the operative note that the surgeon may review and finalize later.

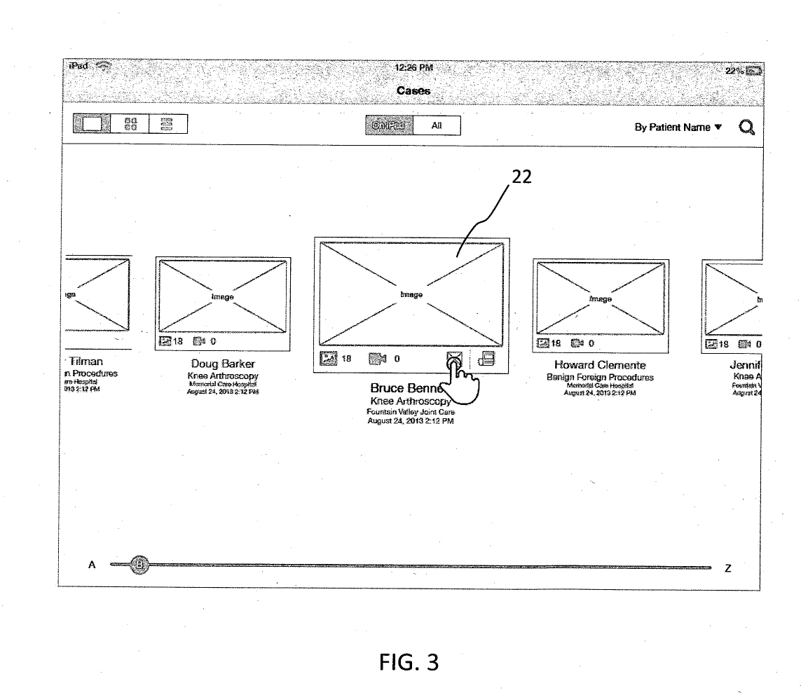

As shown in FIG. 3, following successful login, a user is prompted to select a case file 22 so that the program may locate relevant data in the memory system 14 or from additional systems 20. Relevant data may include, for example, patient information, facility and staff information, pre-operative diagnoses, as well as typical procedures, anesthesia, indications and post-operative diagnoses based on the pre-operative diagnoses.

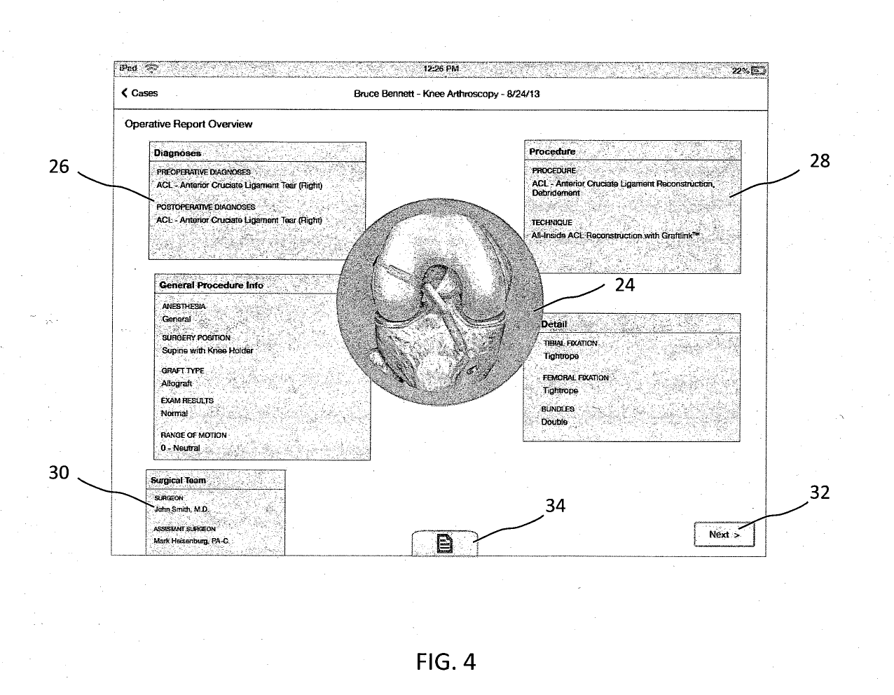

As shown in FIG. 4, once a case file is selected, the program presents the user with an operative report overview screen. The operative report and operative report overview screen is populated with the data obtained from the memory system 14 and/or from additional systems. In an embodiment, the operative report overview screen includes an image 24 of the procedure to be performed for quick visual confirmation by the user. The operative report overview screen may also include a diagnosis section 26, a procedure section 28 and a section about the surgical team 30. The user may select from the various areas of the operative report to edit. Optionally, the user may enter a wizard 32 to review and edit all sections of the operative report. Optionally, the user may select a preview panel 34 that allows the user to view the operative note in progress.

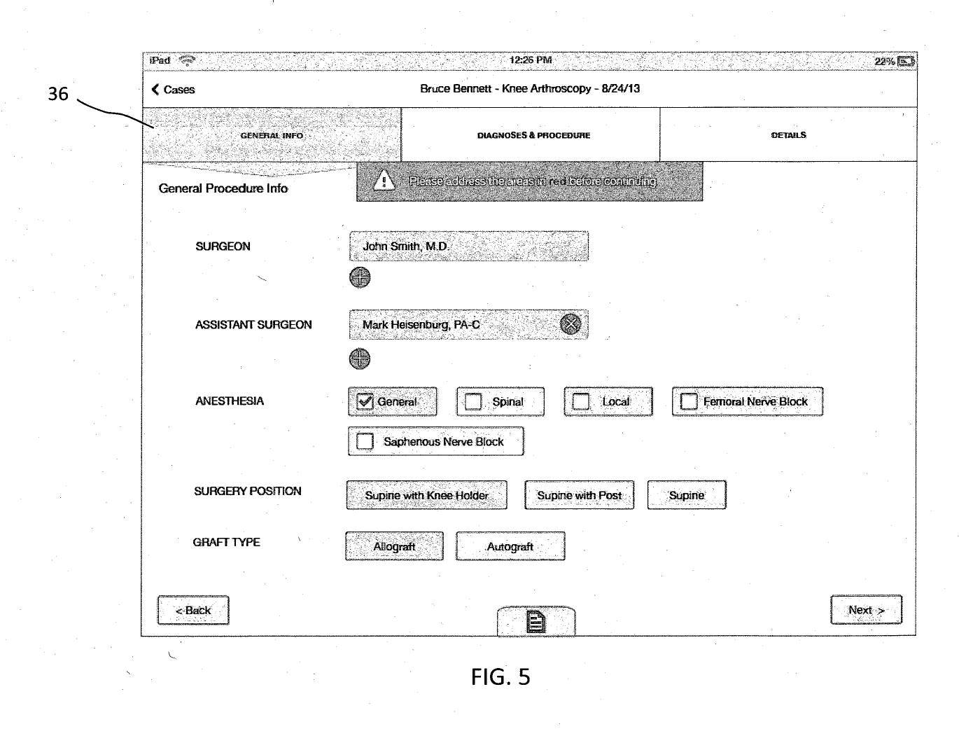

As shown in FIG. 5, once a user selects a general procedure section or the wizard to edit all sections of the operative report, the user is presented with a procedure general information screen. In an embodiment, the screen contains a navigation bar 36 which indicates what portion of the operative note is being edited. The user may select different entries on the navigation bar to view and edit different portions of the operative note. The user is prompted to confirm entries automatically populated by the program. For example, the name of the surgeon may be automatically populated based on the user who has logged into the system.

The user is prompted to provide entries to those sections that could not be automatically populated. The user may be presented with a finite number of options from which to select based on already known information, such as in drop down menus or via radio button selections. For example, the user may be prompted to select an assistant surgeon from a pull-down menu of assistant surgeons at the facility. For example, the user may be prompted to select an anesthesia type from a list of different anesthesia types associated with a given surgical procedure. Certain default selections may be preselected by the system, such as those options most frequently selected by the user (or all users) in the past.

Additionally, a user may have the option to select a free form field (labeled such as “other”) and type language into the form. The user may also enter language into the operative note using voice to text insertion. A user may not be allowed to navigate away from a given screen until the user has entered and confirmed certain information on a given screen.

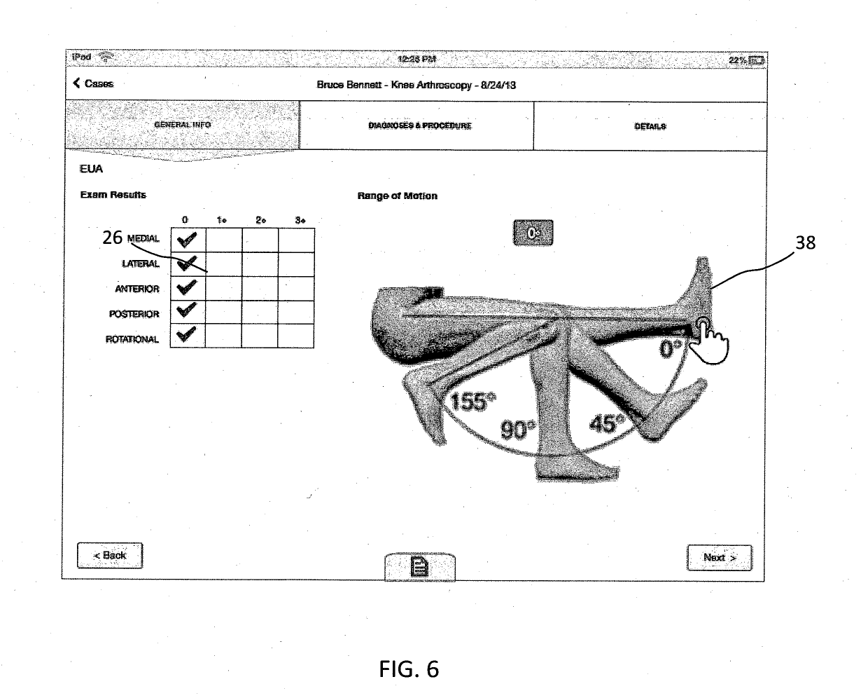

A user may be presented with multiple screens for sections of the operative note. Some screens may prompt a user to graphically enter information. As shown in FIG. 6, a user may be prompted, for example, to move a graphic 38 to indicate a range of motion of a patient's knee. For example, the user may move the leg relative to the thigh to show range of motion. The final position of the leg relative to the thigh may be used to generate text for the operative report. Additionally, the final operative report may have a graphic representation of range of motion.

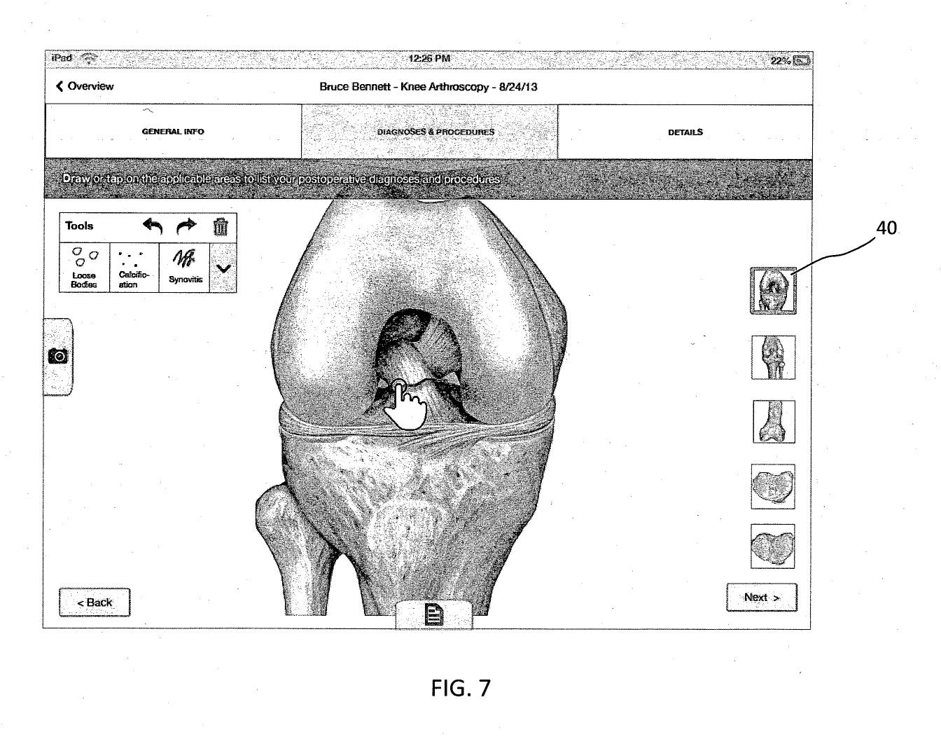

The system presents a user with screens for editing the diagnosis and procedures. As shown in FIG. 7, a user may be presented with a screen containing an image or diagram of the anatomy of the area (such as a knee, hip, elbow or shoulder joint) to be treated. FIG. 7 shows images of a knee. The user may be prompted to select different views 40 (images) of the area. For example, there may top, bottom, left, right and cutaway views of the area. In an embodiment, depending on the image selected and the notation placed over the image, text is generated. For example, if a user draws a line across a portion a ligament as shown in FIG. 7, the system interprets the line as a tear to a specific ligament and will obtain and modify appropriate text from the memory system about the tear.

In an additional embodiment, the location, shape and orientation of user notations are used to select and customize text. For example, if a user draws a line across approximately three quarters of a knee cartilage, the system detects that the user is drawing a 75% tear of the cartilage at a very specific location of the cartilage. The system then translates this concept into meaningful text. Alternatively, a user may select an area of the image (such as by tapping a touchscreen or clicking a mouse) and be prompted to select from various problems associated with the structure in the portion of the image selected by the user.

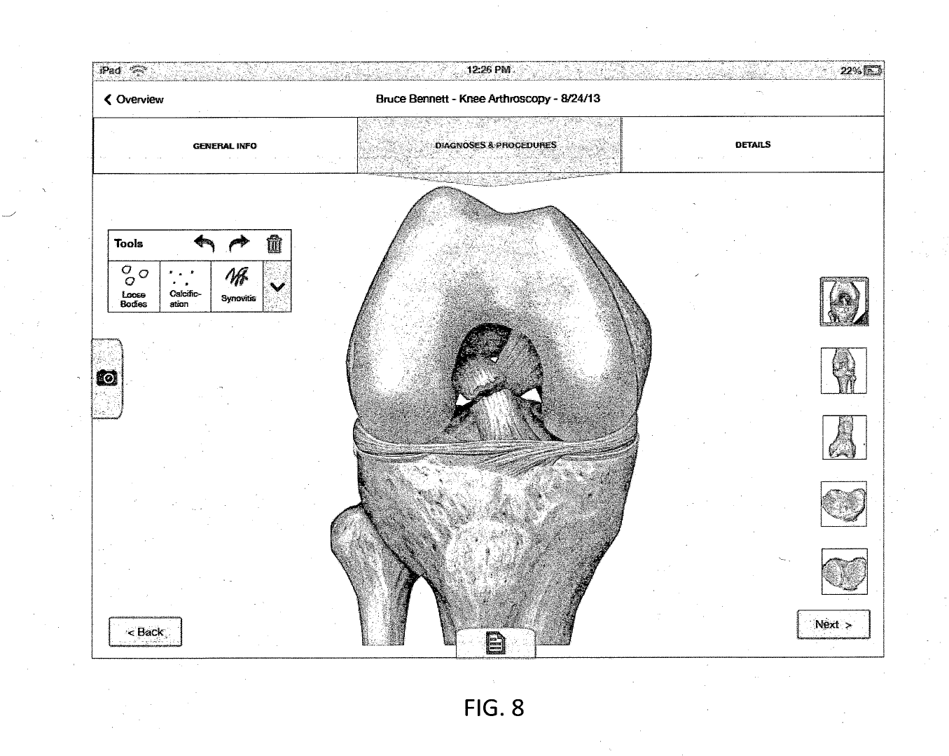

In an embodiment, as shown in FIG. 8, once a user places a notation over the image, a new image may be provided showing the indicated diagnosis for visual confirmation by the user.

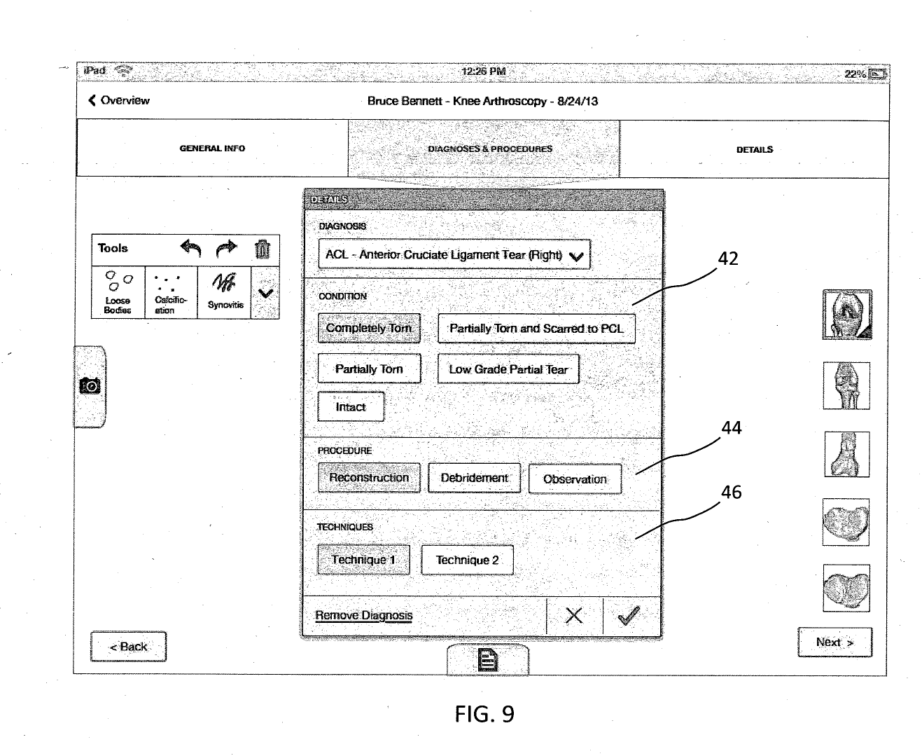

As shown in FIG. 9, once a user has drawn or selected a diagnosis, the user is presented with a lists of conditions 42, procedures 44 and techniques 46 to select from based on the diagnosis. The system may present default procedures and techniques for confirmation by a user. The default procedures may be selected based on, for example, the facility or the user, or the selected surgeon. If there is only one type of procedure and technique for a given diagnosis, then the system may skip the editing screen.

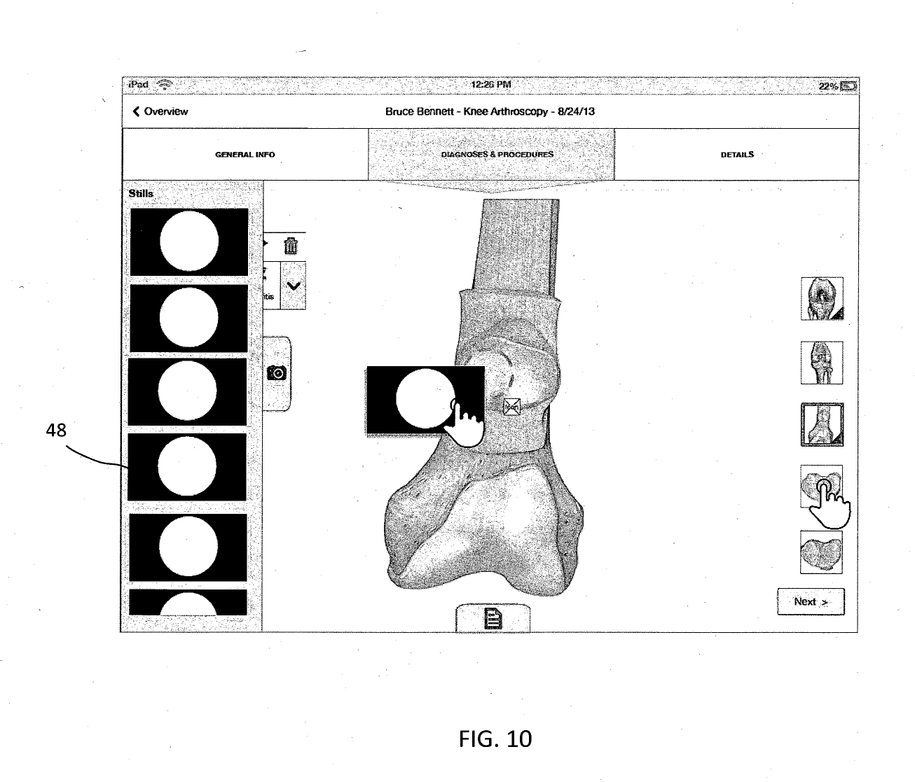

In an embodiment, as shown in FIG. 10, the user is prompted to add pre-operative or operative photographs 48 showing the problem for inclusion in the report. In an embodiment, the user is presented with a series of pre-operative or operative still photographs from the patient and the user may select one or more photographs. In an additional embodiment, the user may select and drag one or more photographs to locations on a graphic background indicating the anatomic structure at issue. In an additional background a user may select pre-operative or operative video from the patient for inclusion in the report.

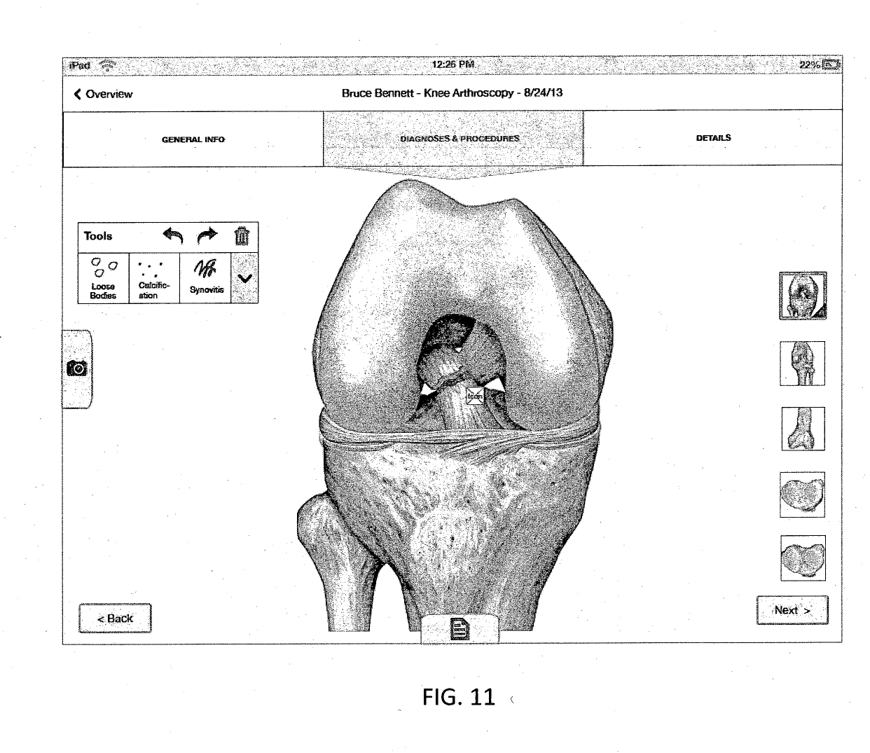

As shown in FIG. 11, once a procedure type has been entered, the user is presented with modified images of the areas showing that the diagnosis has been addressed. Optionally, the user is presented with modified images showing the effect of the procedure. This allows the user to visually confirm the procedure. The user may be prompted to select an area of the images to modify the diagnosis and/or procedure.

In an embodiment, the user is prompted to add operative photographs of the patient showing the performed procedure and the results of the procedure for inclusion in the report. The procedure for adding operative photographs may be the same as described above with reference to FIG. 10 for adding preoperative and operative photographs indicating the diagnosis.

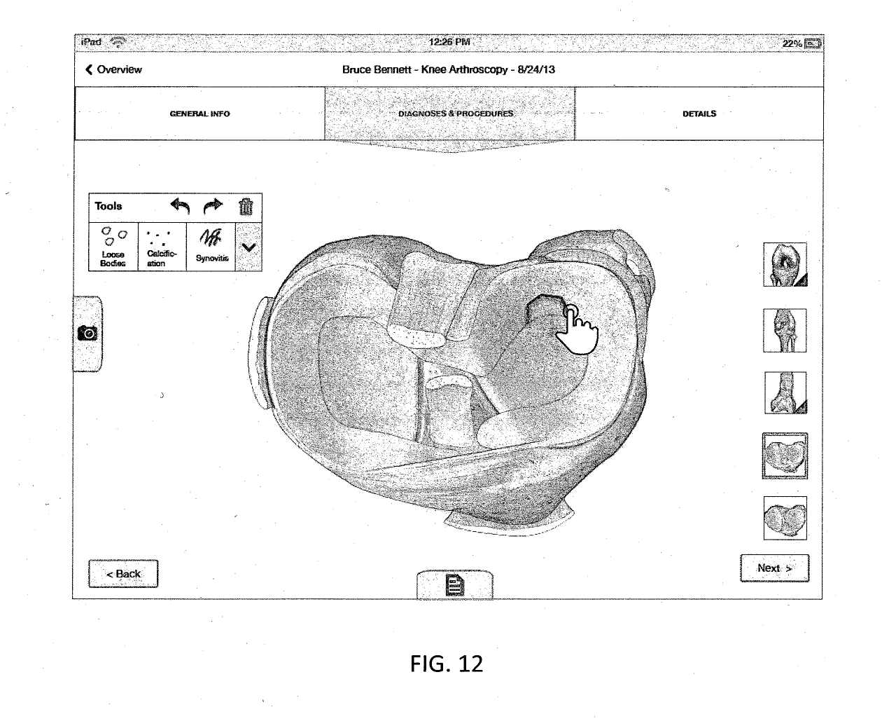

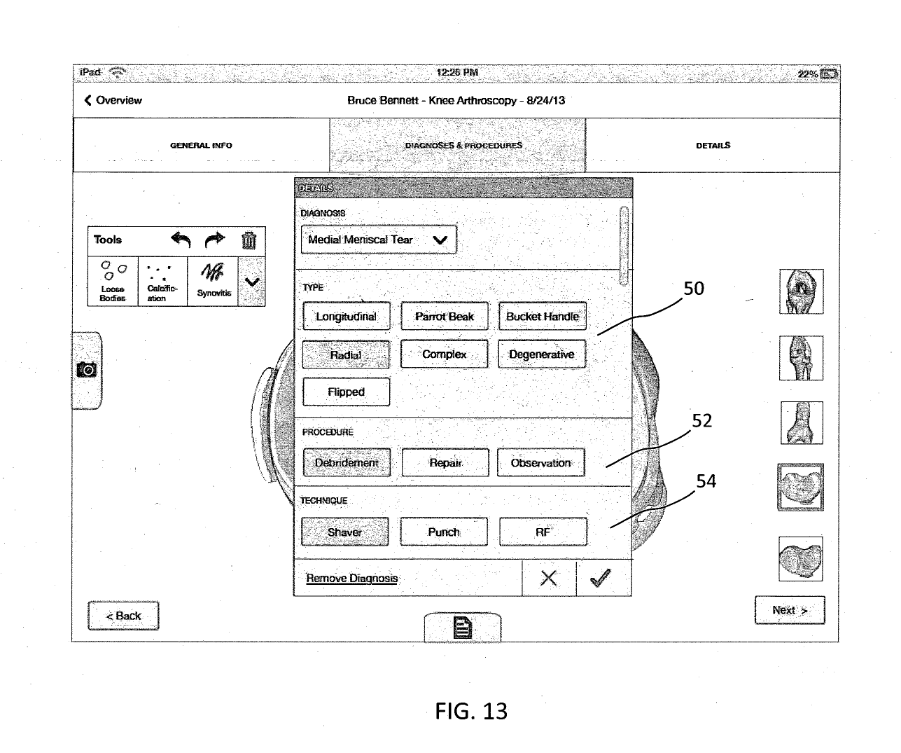

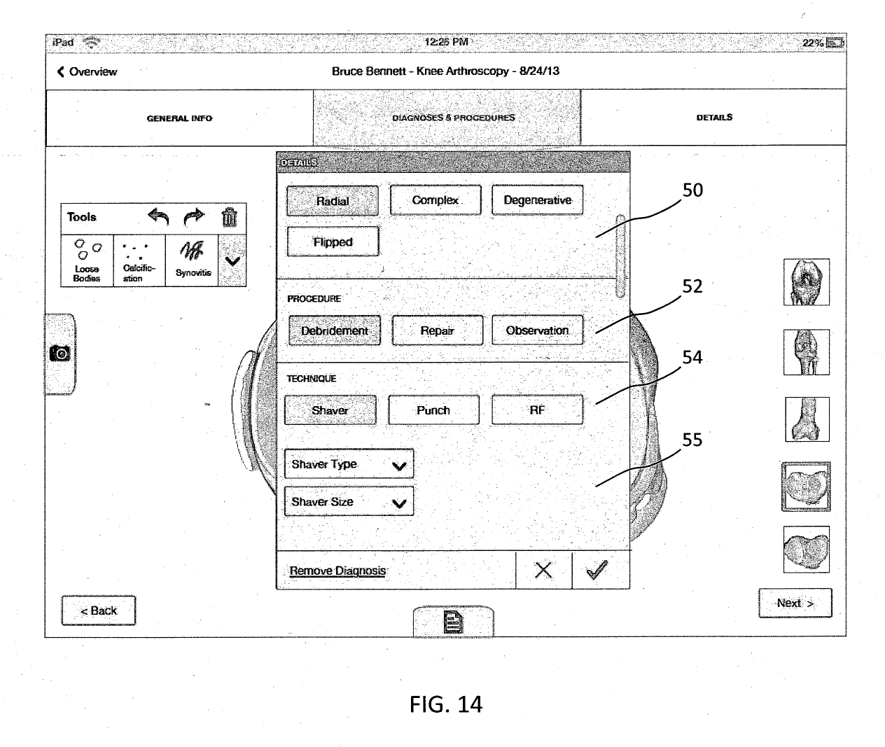

FIGS. 12 to 15 show an example of screens for an operative note relating to a knee meniscus tear. In FIG. 12, a user has drawn a tear over an image of a knee meniscus. Based on the shape drawn by the user and the location of the shape, the system interprets the drawing as a given diagnosis. Once the given diagnosis is determined, the system correlates default procedures with the given diagnosis and presents the given diagnosis and procedures to the user for modification and confirmation. As shown in FIG. 13, once the general diagnosis has been received, the user is presented with a screen to further clarify the diagnosis and procedure. The system may display default diagnosis characteristics 50 selected based on, for example, the most common characteristics or other criteria, such as patient data. The system may display default procedure characteristics 52 selected based on, for example, the most common procedure or other criteria, such as surgeon preferences. The system may display default treatment techniques 54 selected based on, the most common treatment techniques for the selected procedure(s). FIG. 14 shows the screen of FIG. 13, but scrolled further down so that further information about a shaver technique 55 may be specified by the user.

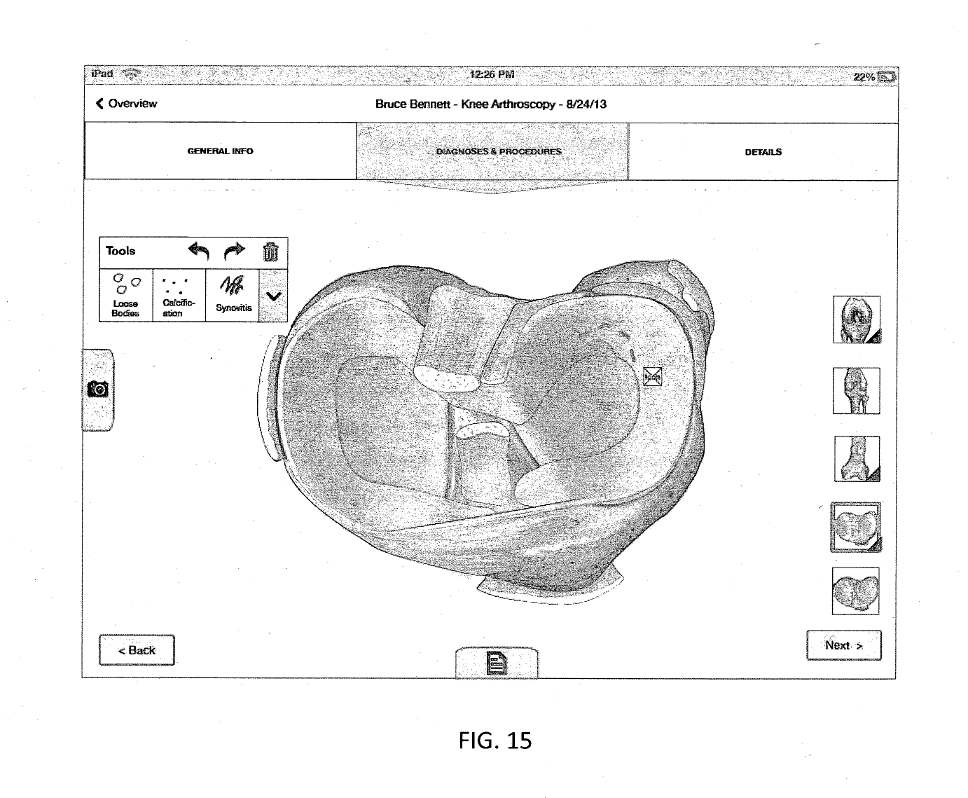

As shown in FIG. 15, once the diagnosis and procedure information has been confirmed, the user is presented with a screen with an image showing that the diagnosis and procedure have been addressed. This allows the user to visually confirm the procedure and further edit the diagnosis and procedure as necessary.

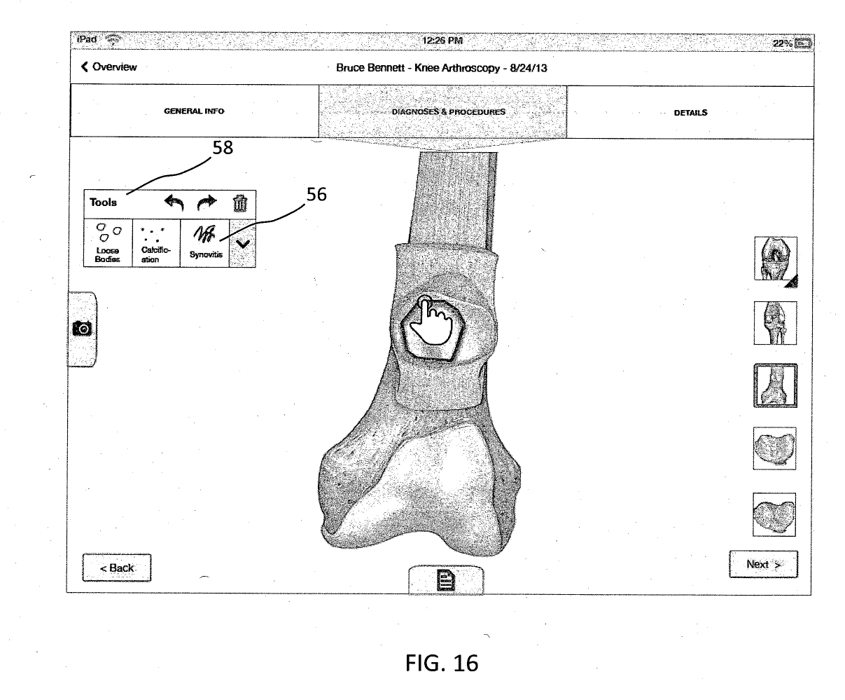

FIGS. 16 to 20 show another example of diagnosis and procedure selection for an operative note relating to knee chondromalacia. As shown in FIG. 16, a user has indicated an area of knee chondromalacia on an image. The user may select a diagnosis type icon 56 from a diagnosis toolbar 58 and then select a portion of the image where the diagnosis type occurs. For example, a user may select “calcification” and then select an area of the image where the calcification occurs. The system then uses the calcification selection and coded location information on the image to generate diagnosis text for the operative note.

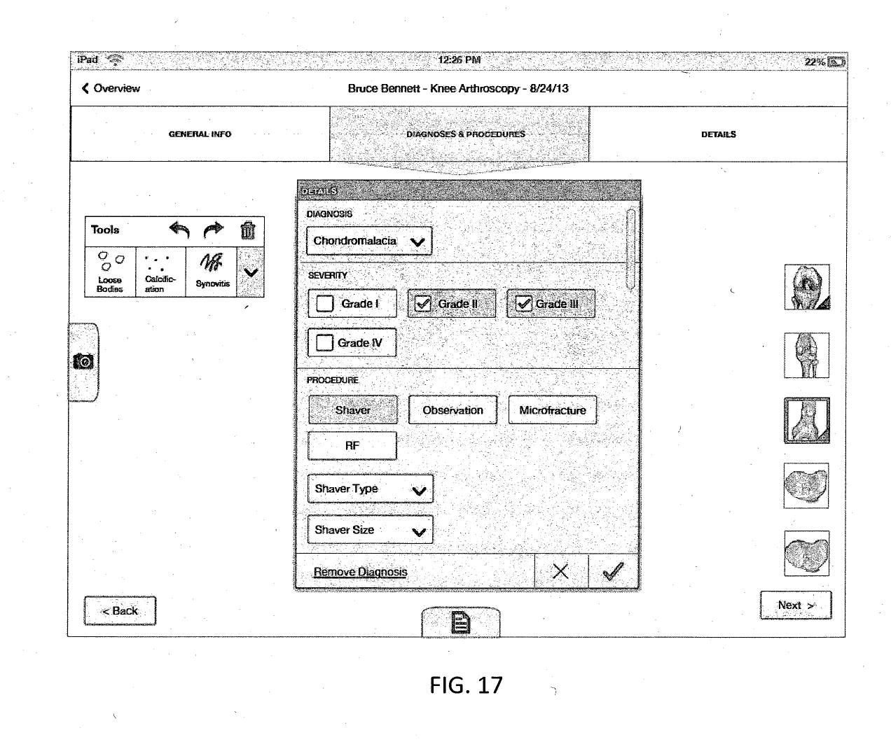

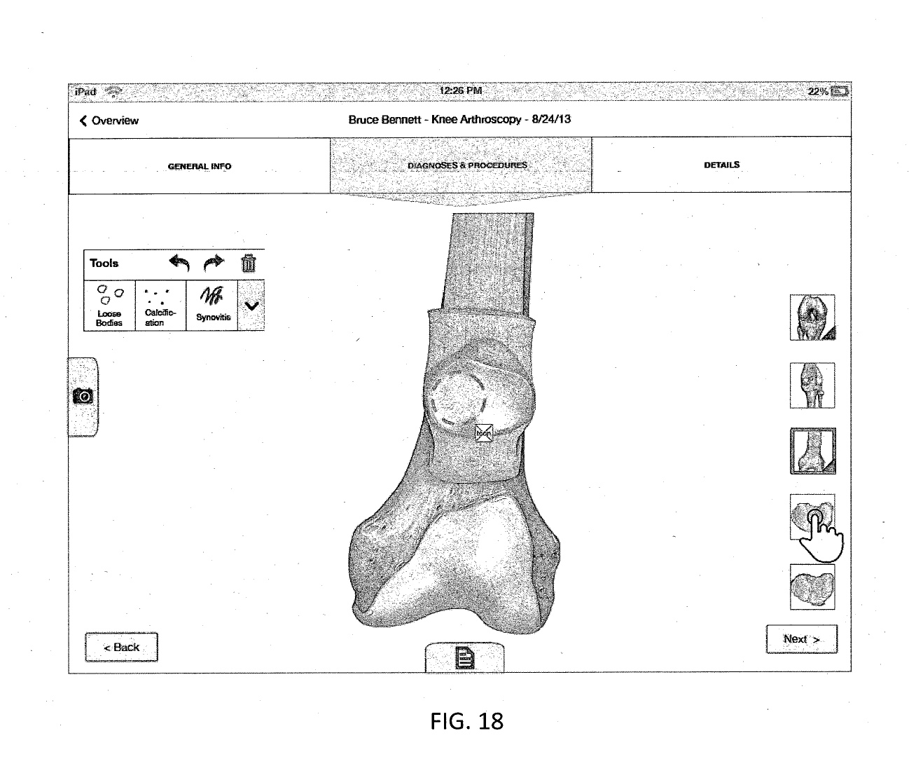

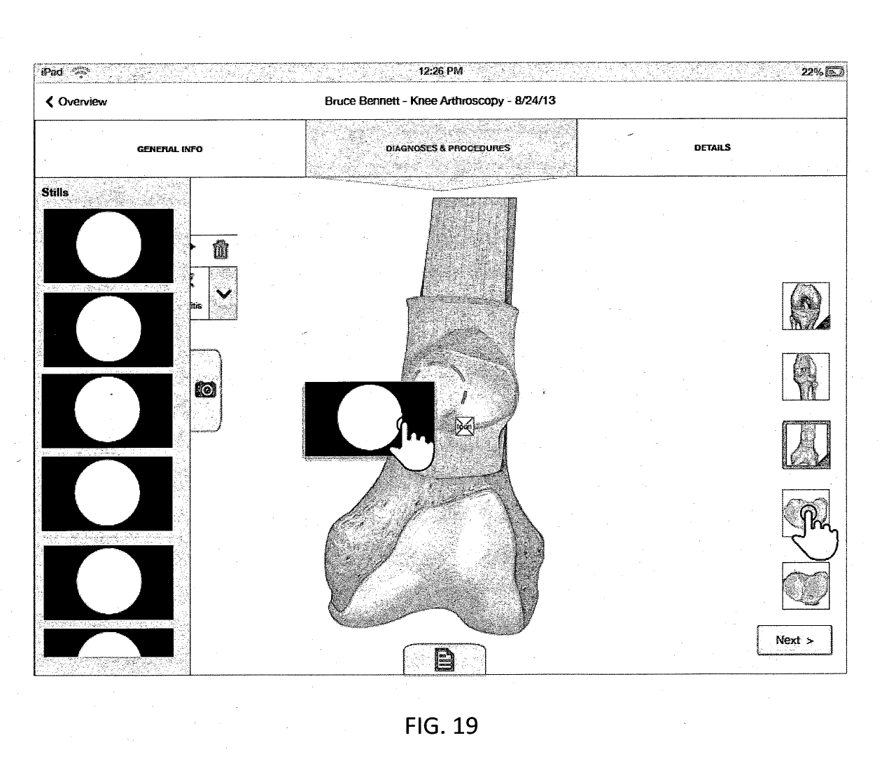

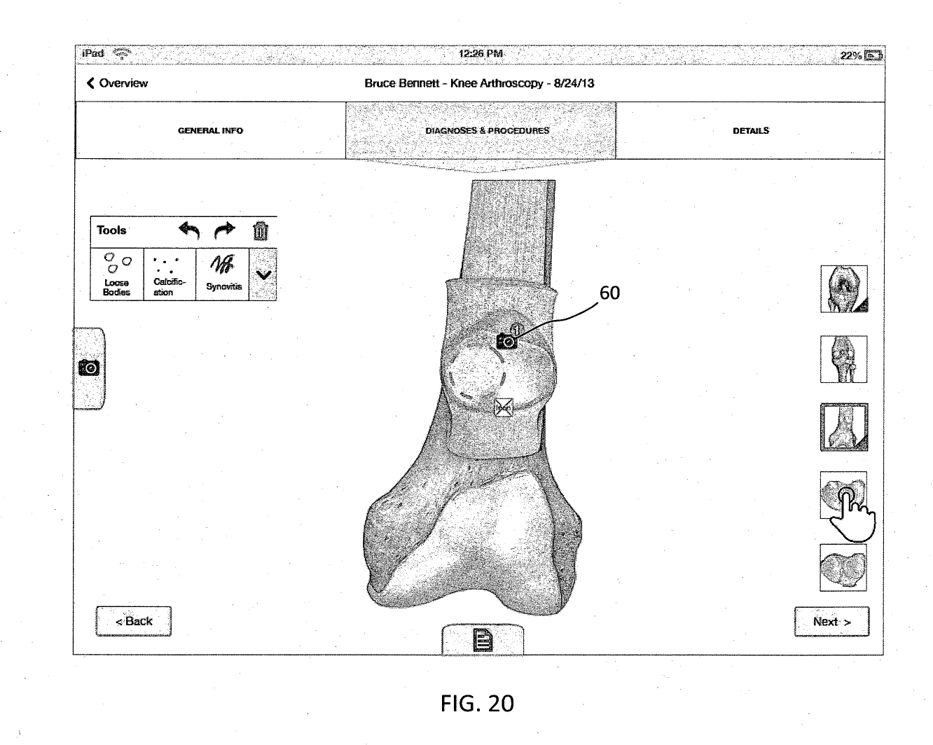

As shown in FIG. 17, the user is prompted to modify a diagnosis, a severity and a procedure for treating for the diagnosis. As shown in FIG. 18, the user is presented with a modified graphic showing the identified diagnosis and procedure. As shown in FIG. 19, the user is prompted to select one or more images for inclusion in an operative note. As shown in FIG. 20, once the user has selected one or more images for inclusion, the system displays an icon 60 to indicate that selection has been made.

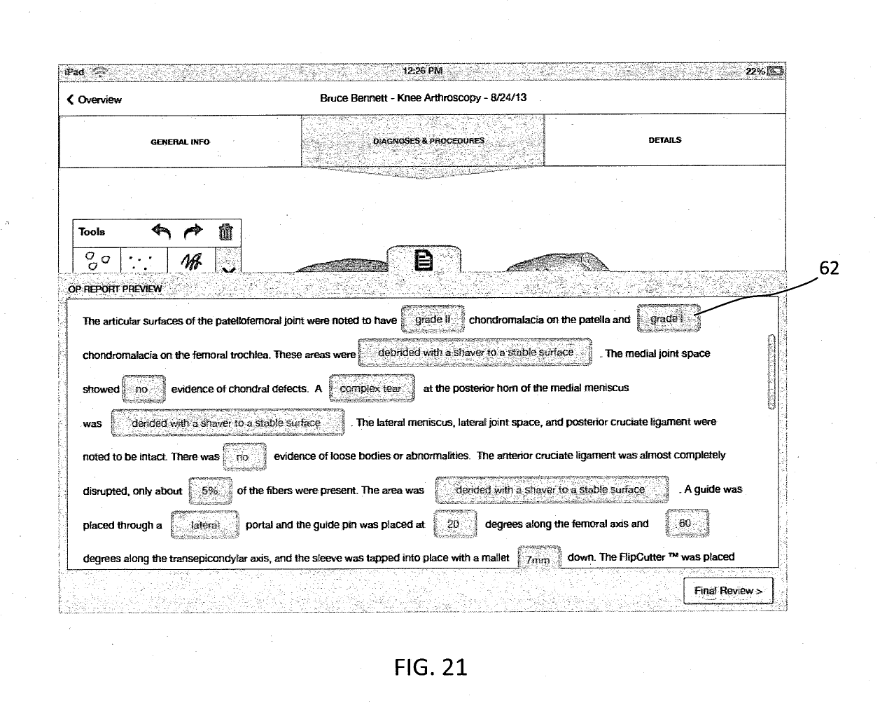

As shown in FIG. 21, the user may select to see a preview of the operative note showing the generated text. The user may directly modify the text or return to the previous interface to generate the remainder of the operative note. The user may modify the text, such as by typing or dictation. Additionally, as shown in FIG. 21, the preview may have “hotspots” as indicated by the shaded portions of text 62. If a user selects a hotspot, the user may be prompted to select other text options for that hotspot or enter their own text for that hotspot. In an embodiment, portions of the operative note include standard text for normal anatomical structures unless the user indicates exceptions or abnormalities. Hotspots may also take the user to the relevant portion of the graphical user interface to modify the section (e.g. the diagnoses and procedures) as previously described.

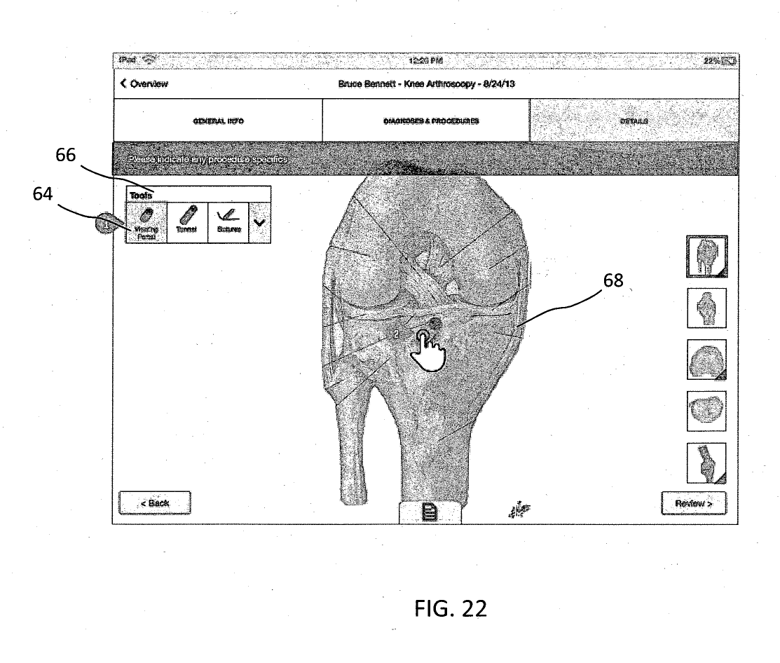

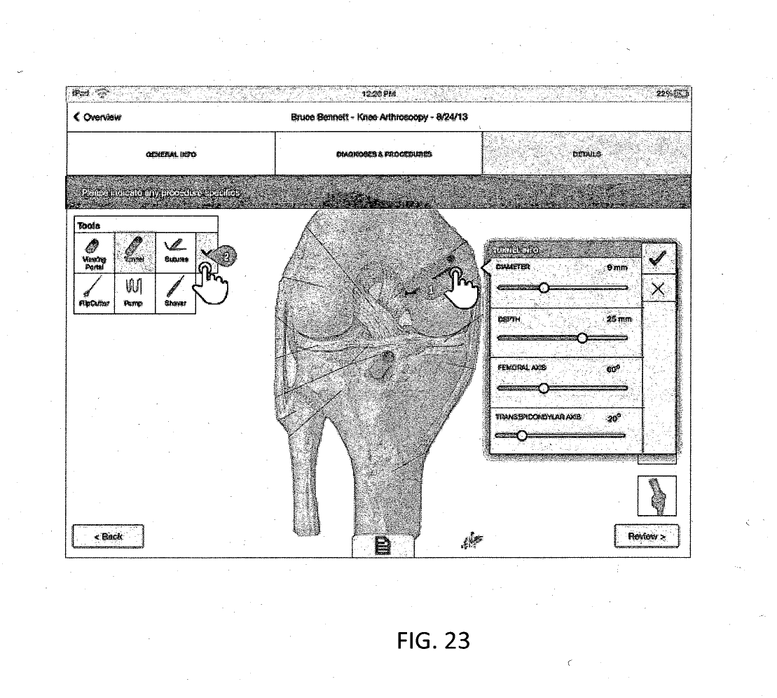

In an additional embodiment of the present invention, as shown in FIG. 22, a user may be prompted to graphically enter details about a procedure by selecting a procedure tool icon 64 from a procedure toolbar 66 and placing the selected tool at a location on an image 68. As shown in FIG. 23, upon placement of the procedure tool at a location on a given image, the system generates text based on the procedure tool selected and location information coded in the image 68. The user may then be prompted to enter additional information about the use of that tool. The user may be prompted to enter that additional information graphically such by adjusting an orientation of the selected tool or via sliders.

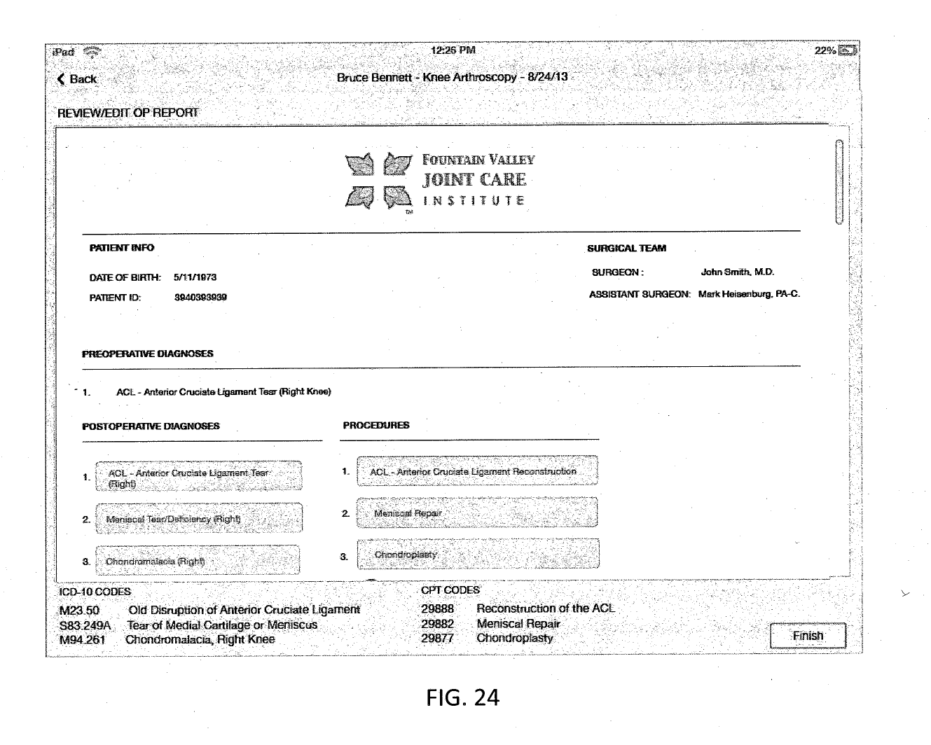

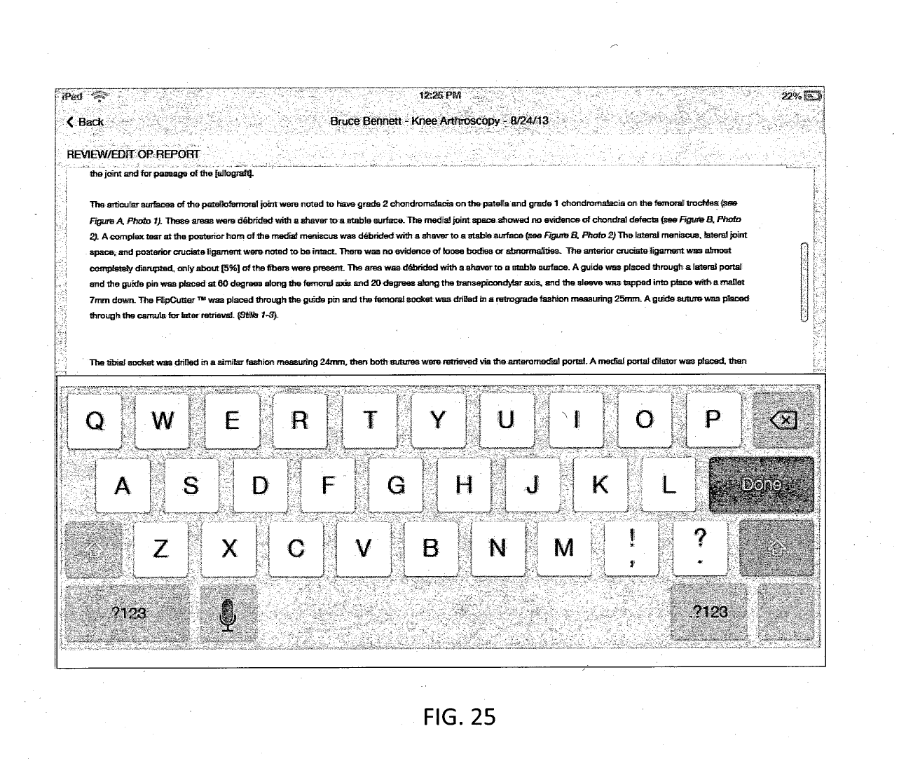

As shown in FIG. 24, once information has been gathered and entered, the user is provided with a draft operative report for review. The user may select various text portions for which different options are provided. Additionally, as shown in FIG. 25, the user may add text using dictation, an input device and/or an on screen keyboard. In an embodiment, the system provides diagnosis codes such as ICD-9 and/or ICT-10 codes based on the diagnosis selected by the user. In an additional embodiment, the text generator may add procedure codes, such as CPT codes. Specific diagnosis codes such as ICD-9 and/or ICT-10 codes may be selected based on the graphical inputs of a user.

Many elements of the draft operative report in FIG. 24 are pre-populated from patient information, facility and staff information, pre-operative diagnoses information retrieved by the system from the memory system 14 or from additional systems 20, such as in response to selection of a case file as described above with reference to FIG. 3.

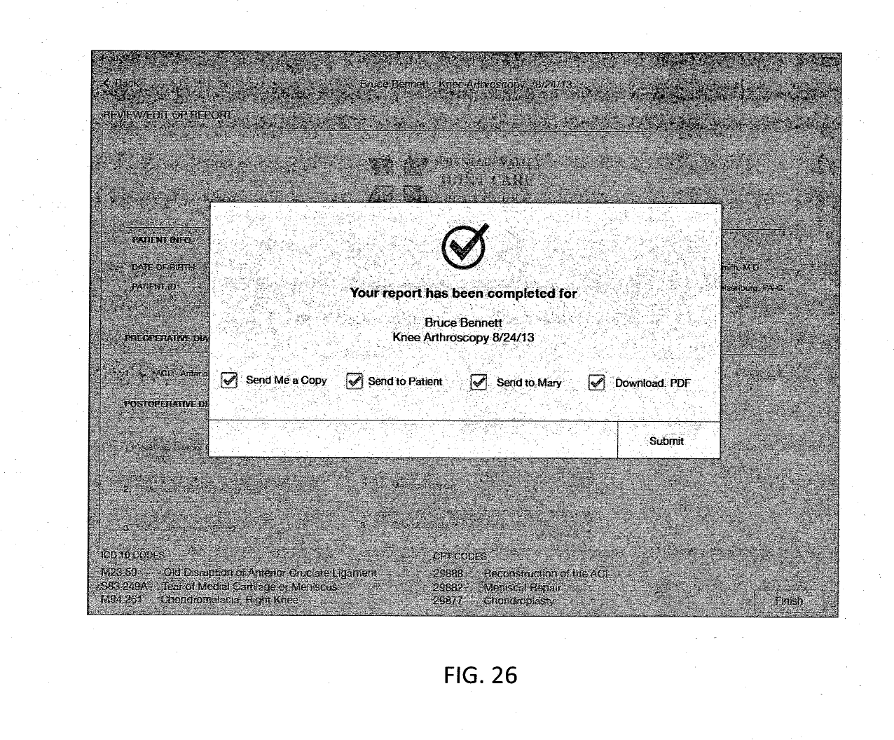

As shown in FIG. 26, upon completing their review, the user is prompted to send the completed operative note to one or more destinations. The destinations may include a printer. Additionally, the report may be digitally output to, for example, a hospital server, doctor's office, surgeon vault (a cloud based server securely storing surgeon and patient specific information), user computer, email recipients and a USB key. The report may be a plain text file such as for loading into an electronic medical record. The report may also be output in different formats such as PDF, common word processing files such as Microsoft Word®, and HTML. The report may also be output in graphic formats, such as JPEG, BMP, GIF and PDF.

Information from the operative report may be used to create patient reports or other reports. Additionally, information from patient reports or other reports prepared by the surgeon for a given patient and procedure may be imported into the draft operative note to streamline preparation of the operative note.

According to an embodiment, the present invention allows for graphic indication of diagnoses and procedures; further refinement of the diagnoses and procedures using menus specific to the indicated diagnoses and procedures; and generation of a detailed textual operative note that does not sound like canned or machine generated text. This process is aided by customizing the diagnoses and procedures using preferences of, for example, a user, a hospital and a patient. The present invention, according to an embodiment allows for users, such as surgeons, to store diagnoses and procedure preference information as well as descriptive text in one of the additional systems 20 accessible by the system 10. In an embodiment, the other system 20 where the user's preferences are stored is a cloud based memory device.

Advantages for the doctor or surgeon include, quick and easy generation of post-operative notes. No dictation is necessary. Operative notes are immediately accessible for use in the doctor or surgeon's EMR. Moreover, the present invention allows for graphical representation of surgical procedures, to augment or replace text, to aid a reader in more quickly and easily comprehending the pathology and surgical procedures performed.

Advantages for a hospital or surgery center include: substantially decreased transcription costs, immediate, timely operative note integration into a patient's chart, and improved surgeon compliance. The present invention allows for improved compliance with government meaningful use mandates.

There is disclosed in the above description and the drawings, a system and method for creating operative notes which fully and effectively overcomes the disadvantages associated with the prior art. However, it will be apparent that variations and modifications of the disclosed embodiments may be made without departing from the principles of the invention. The presentation of the preferred embodiments herein is offered by way of example only and not limitation, with a true scope and spirit of the invention being indicated by the following claims.

Any element in a claim that does not explicitly state “means” for performing a specified function or “step” for performing a specified function, should not be interpreted as a “means” or “step” clause as specified in 35 U.S.C. §112.

What is claimed is:

1. A system for graphically generating operative notes, the system comprising:
a processor;
an input device coupled to the processor;
a display device coupled to the processor; and
a memory system coupled to the processor, the memory system comprising:
graphical representations of at least one of the group consisting of anatomical structures, diagnoses, and medical procedures;
text descriptions corresponding to the graphical representations; and
instructions executable on the processor for:
displaying the graphical representations on the display device for a user to select;
receiving selected graphical representations from the user;
using text corresponding to the selected graphical representations to generate text for operative notes; and
allowing the user to edit the generated text using the input device.

2. The system of claim 1 wherein the memory system further comprises data regarding at least one of a patient, a medical facility and medical personnel; and wherein the instructions executable on the processor further comprise instructions for using the data regarding at least one of a patient, a medical facility and medical personnel to generate text for operative notes.

3. The system of claim 2 wherein the memory system further comprises text descriptions for at least one of pre-operative diagnoses, procedures, anesthesia, indications and post-operative diagnoses; and wherein the instructions executable on the processor further comprise instructions for selecting from the text descriptions based on the selected graphical representations and the data regarding at least one of a patient, a medical facility, a medical procedure and medical personnel to generate text for operative notes.

4. The system of claim 1 wherein the instructions executable on the processor further comprise instructions for providing graphical representations based on the user.

5. The system of claim 1 wherein the instructions executable on the processor further comprise instructions for providing graphical representations based on a medical procedure.

6. The system of claim 1 wherein the system resides on a mobile computing device and the display device is a display screen of the mobile computing device.

7. The system of claim 6 wherein the input device is a touch screen of the mobile computing device.

8. The system of claim 1 wherein the memory system further comprises operative photographs of a patient; and wherein the instructions executable on the processor further comprise instructions for prompting a user to select at least one of the operative photographs for inclusion in operative notes and for including the at least one selected operative photographs in the operative notes.

9. A method for generating operative notes, the method comprising the steps of:
providing a user with graphic representations of anatomical structures, diagnoses and medical procedures;
prompting a user to graphically indicate at least one diagnosis using the graphic representations;
receiving a graphic indication of at least one diagnosis from the user;
generating operative note text from the received graphic indication of at least one diagnosis;
prompting the user to graphically indicate at least one medical procedure using the graphic representations;
receiving a graphic indication of at least one medical procedure from the user; and
generating operative note text from the received graphic indication of at least one medical procedure.

10. The method for generating operative notes of claim 9 further comprising the steps of:
prompting the user to login to the system using a password;
receiving the password from the user;
authenticating the password received from the user;
prompting the user to select from a plurality of different cases;
receiving a case selection from the user;
retrieving data corresponding to the selected case from a memory; and
populating a portion of an operative note with the retrieved data.

11. The method for generating operative notes of claim 10 wherein the retrieved data contains at least one of a patient name, a patient sex, a patient date of birth, a patient medical record number.

12. The method for generating operative notes of claim 11 further comprising:
storing information about at least one of a medical facility and medical personnel in a storage device;
retrieving the information about at least one of a medical facility and medical personnel from the storage device; and
populating a portion of an operative note based on the retrieved information about at least one of a medical facility and medical personnel from the storage device.

13. The method for generating operative notes of claim 12 further comprising:
storing text descriptions for diagnoses, medical procedures, anesthesia, indications and post-operative diagnoses in a storage device; and
selecting text from the text descriptions based on the received graphic indication of at least one diagnosis, the received graphic indication of at least one medical procedure, the retrieved data corresponding to the selected case and the retrieved information about at least one of a medical facility and medical personnel.

14. The method for generating operative notes of claim 13 further comprising the steps of prompting the user to review a draft operative note; receiving edits from the user; and generating a final operative note.

15. The method for generating operative notes of claim 14 further comprising the steps of: prompting the user to select from a plurality of destinations for the final operative note; receiving at least one destination selection from the user; and sending the final operative note the to the at least one selected destination.

16. The method for generating operative notes of claim 9 wherein the step of providing the user with portions of an operative note containing graphic representations further comprises selecting graphic representations based on the user.

17. The method for generating operative notes of claim 9 wherein the steps of generating operative note text from the received graphic indication of at least one diagnosis and generating operative note text from the received graphic indication of at least one medical procedure further comprise selecting text based on the user.

18. A system for graphically generating operative notes, the system comprising:
an operative note generating module further comprising;
a processor;
a first memory system coupled to the processor, the memory system comprising graphical representations of anatomical structures, diagnoses, and medical procedures;
an input device coupled to the processor; and
a display device coupled to the processor;
a data storage system coupled to the operative note generating module, the data storage system further comprising data regarding a patient, a medical facility and medical personnel;
wherein the operative note generating module processor is configured to:
provide the graphical representations to a user for selection;
receive selected graphical representations from the user;
use the selected graphical representations to generate text for operative notes; and
use the data regarding at least one of a medical facility and medical personnel to generate text for operative notes.

19. The system of claim 18 wherein the first memory system further comprises text descriptions for at least one of pre-operative diagnoses, procedures, anesthesia, indications and post-operative diagnoses; and wherein the processor is further configured to select from the text descriptions based on the selected graphical representations and the data regarding at least one of a patient, a medical facility, a medical procedure and medical personnel to generate an operative note.

20. The system of claim 18 wherein:
the system resides on a mobile computing device;
the display device is a display screen of the mobile computing device; and
the input device is a touch screen of the mobile computer device.
